(19) United States
(12) Patent Application Publication
(10) Pub. No.: US 2004/0109535 A1
(43) Pub. Date: Jun. 10, 2004

(54) Photo sense element and operation mode

(76) Inventors: Sen-Hsiung Fan, Hsinchu (TW); Huey-liang Hwang, Hsinchu (TW); Yu-Ling Jiang, Taichung (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/065,979

(22) Filed: Dec. 5, 2002

(51) Int. Cl. H05G 1/64

(52) U.S. Cl. 378/98.8

(57) ABSTRACT

A photo sense element that is composed of a P-type doped layer, a N-type doped layer, an intrinsic layer, a first electrode corresponding to the P-type doped layer, a second electrode corresponding to the N-type doped layer and a dielectric layer. Wherein, the intrinsic layer is disposed in between the P-type doped layer and the N-type doped layer to form a diode. Moreover, the dielectric layer is disposed in between the P-type doped layer and the first electrode or in between the N-type doped layer and the second electrode to form a dielectric layer capacitor. By using the appropriate circuit design to have the parasitic capacitor formed by the diodes under the reverse bias state in parallel with the dielectric layer capacitor, so the photo sense element has greater capacitance. Furthermore, the operation mode of the photo sense element of the present invention is to charge the dielectric layer capacitor of the element before the photons are sensed, and to process the photo sensing and signal reading after the charging.

### BACKGROUND OF INVENTION

1. Field of Invention

The present invention generally relates to a photo sense element and the operation mode, and more particularly, to a photo sense element having a dielectric layer capacitor on one side of the diode and its operation mode.

2. Description of Related Art

The solid state X-ray sense element is one of the major development fields endeavored by all the industrial countries nowadays. It is because the X-ray sense element matches to the tide of the electronics trend of the age. It can be used to replace traditional X-ray film and has the advantage of no need to develop the film. By using the X-ray sense element, the image of the object is displayed on the computer directly after exposure. Since film development is not needed for the X-ray sense element, the environmental pollution problem caused by film development can be reduced accordingly. Moreover, the X-ray sense element has the advantages of obtaining the image fast, it is easy to configure the entire image system, easy to carry on, and the obtained image can be digitalized directly, which is convenient for transmission and storage. All of these advantages demonstrate the potential of the X-ray sense element to replace the X-ray film in the future.

The general solid state X-ray sense element can be divided into two categories, one is the direct X-ray sense element, the other is the indirect X-ray sense element. The direct X-ray sense element is able to detect the X-ray directly without the help of the scintillator. However, for the indirect X-ray sense element, after the X-ray is injected into the scintillator for converting the X-ray into the visible light, the visible light is detected via a photo sensor able to sense visible light.

Please refer to both FIG. 1 and FIG. 2 at the same time; FIG. 1 schematically shows the structure of the conventional photo sense element. FIG. 2 schematically shows the equivalent circuit diagram of the conventional photo sense element. The conventional indirect X-ray sense element is configured on a baseboard 100. A diode 101 having the P doped terminal, the intrinsic layer and the N doped terminal is equipped on the baseboard 100 for use as the photo sense element. The diode 101 is itself composed of a P-type doped layer 102, an N-type doped layer 104, and an intrinsic layer 106 that is located in between the P-type doped layer 102 and the N-type doped layer 104. Moreover, besides the P-type doped layer 102 and the N-type doped layer 104, it further comprises a first electrode 108 that is electrically connected to the P-type doped layer 102, and a second electrode 110 that is electrically connected to the N-type doped layer 104. When a reverse bias is applied in between the first electrode 108 and the second electrode 110, the intrinsic layer 106 in between the P-type doped layer 102 and the N-type doped layer 104 senses the incident light and generates the electron-hole pair to form a photo sense current source I_{L}. The charge generated after sensing is stored in the parasitic capacitor C_{d} that is formed by the three layers, the P-type doped layer 102, intrinsic layer 106 and the N-type doped layer 104.

If only the parasitic capacitor C_{d} of the diode 101 is used to store the charge, the parasitic capacitor C_{d} must be big enough, and the leakage current related to the diode reverse bias leakage resistor R_{dsh} must be small enough, so that the indirect X-ray sense element configured of the diode 101 can achieve the objective of practical utilization. The conventional technique must consider the aspects of the improvement of the photo-electronic effect of the diode itself, the improvement of the parasitic capacitor C_{d}, and the reduction of the leakage current. However, no matter if it is the photo-electronic effect of the diode itself that is improved, or the parasitic capacitor C_{d}, or the leakage current, not only is the manufacture technique getting more and more complicated, but also there is contradiction inherent between each improved item (the improvement of the photo-electronic effect of the diode itself, the improvement of the parasitic capacitor C_{d} and the reduction of the leakage current).

The quantity of the charge that can be stored in the parasitic capacitor layer of the conventional sense element is quite limited. Thus, the parasitic capacitor layer is very easily saturated when the photons are sensed, so that the operation range of the photo sense element is not large enough. Moreover, the problem of low manufacture consistence quite often occurs in the conventional photo sense element.

Furthermore, if the leakage current is quite severe, the conventional photo sense element also has the problem of short data holding time that results in the signal being decayed and vanishing after the photons are sensed.

### SUMMARY OF INVENTION

Therefore, the objective of the present invention is to provide a photo sense element that is able to greatly increase the data holding time of the photo sense element, including the advantages of the ease of manufacture, and high consistence.

In order to achieve the objective mentioned above, the present invention provides a photo sense element that is composed of a P-type doped layer, a N-type doped layer, an intrinsic layer, a first electrode corresponding to the P-type doped layer, a second electrode corresponding to the N-type doped layer and a dielectric layer, wherein the intrinsic layer is disposed in between the P-type doped layer and the N-type doped layer to form a diode. Moreover, the dielectric layer is disposed in between the P-type doped layer and the first electrode or in between the N-type doped layer and the second electrode to form a dielectric layer capacitor. By using the appropriate circuit design, such as to virtual short the first electrode and the second electrode, so that the parasitic capacitor formed from the P-type doped layer, the intrinsic layer, and the N-type doped layer under the reverse bias is in parallel with the dielectric layer capacitor, thus the photo sense element has greater capacitance.

The independent optimum design of the capacitor of the accumulated charge and the photo sense diode can be achieved by using the structure of the photo sense element of the present invention.

The operation mode of the photo sense element of the present invention first charges the dielectric layer capacitor of the element before the photons are sensed, and processes the operation of the photo sensing and the signal reading after the charging.

The operation mode of the photo sense element of the present invention first processes the charge operation by using a positive bias before the photons are sensed, so as to the dielectric layer capacitor of the element is charged to a certain voltage level, such as 2 volts to 10 volts. Then, the voltage level between the diodes is reduced to such as 0 volt to process the photo sensing. Since the dielectric layer contains an initial voltage such as 2 volts to 10 volts after charging, so that the diode stays in a reverse bias state to process the operation of the photo sensing. Moreover, the photo current generated by the photo sensing will neutralize the charge of the dielectric layer capacitor. A positive bias is applied to the dielectric layer capacitor to process the charge operation again after the photons are sensed. The capacitor is charged to such as 2 volts to 10 volts, so that the charge that is neutralized by the photo sensing is read out, and with this the total photons of the incident light and the dose of the X-ray can be calculated.

The operation mode of the photo sense element of the present invention is providing a reverse bias in between the diodes, wherein the reverse bias is such as 2 volts to 10 volts. The reverse bias is charged to the dielectric layer capacitor first, after the charging approaches to the steady state, most of the voltage falls on the dielectric layer. Afterwards, the reverse bias is maintained in between the diodes and the operation of the photo sensing is processed. Since the charging is in the steady state, thus the diode is processing the photo sensing under a no bias state. The diode forms like a photo volt battery via the irradiation of the light and charges to the dielectric layer capacitor continuously. Afterwards, the charge that is increased on the dielectric layer capacitor when the photons are sensed is read out, thus the total photons of the incident light and the dose of the X-ray can be calculated.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 shows the structure of the conventional photo sense element;

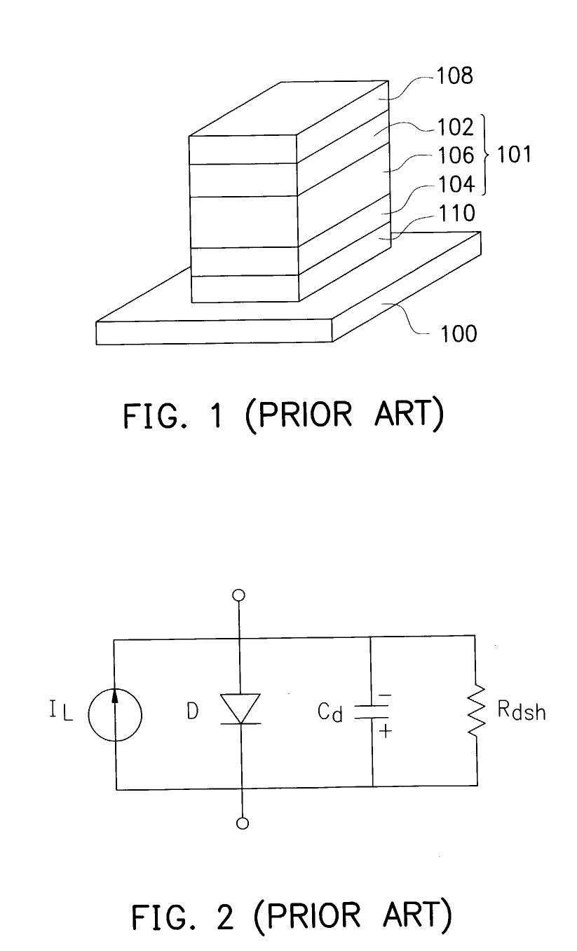

FIG. 2 schematically shows the equivalent circuit diagram of the conventional photo sense element;

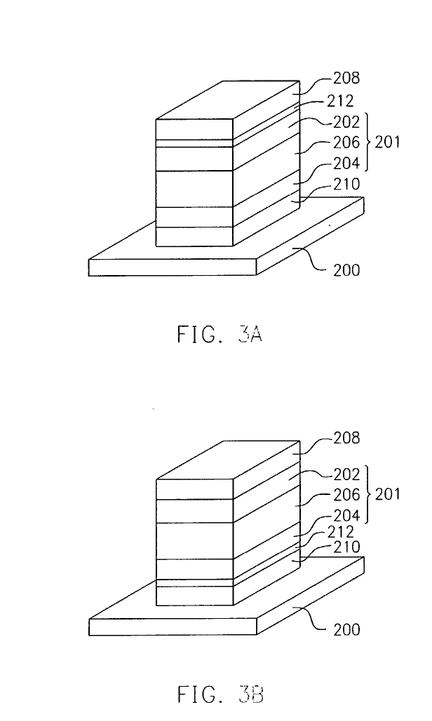

FIG. 3A through FIG. 3D show the structure of the photo sense element of a preferred embodiment according to the present invention;

FIG. 4A and FIG. 4B schematically show the equivalent circuit diagrams of the photo sense element of a preferred embodiment according to the present invention; and

FIG. 5 schematically shows the equivalent circuit diagram of the photo sense element and the signal reading design of a preferred embodiment according to the present invention.

### DETAILED DESCRIPTION

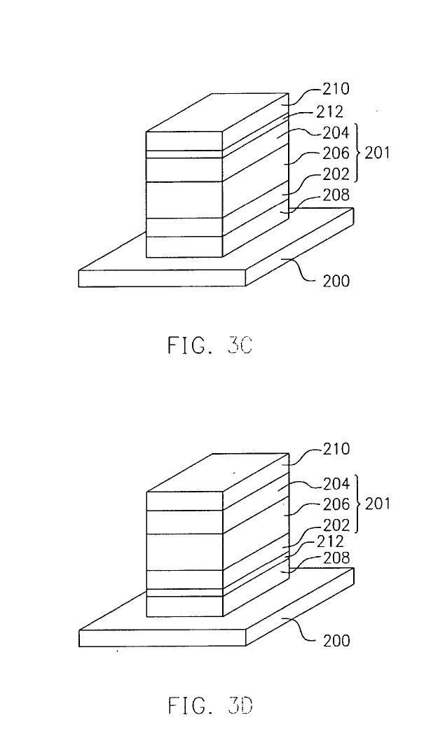

First, please refer to FIG. 3A through FIG. 3D that show the structure of the photo sense element of a preferred embodiment according to the present invention. First, referring to FIG. 3A, the photo sense element of the present invention is configured on a baseboard 200. For example, a second electrode 210, a N-type doped layer 204, an intrinsic layer 206, a P-type doped layer 202, a dielectric layer 212 and a first electrode 208 are disposed in order on and above the baseboard 200. Wherein, since the intrinsic layer 206 is disposed in between the N-type doped layer 204 and the P-type doped layer 202, thus the N-type doped layer 204, P-type doped layer 202 and the intrinsic layer disposed in between forms a parasitic capacitor. Moreover, the P-type doped layer 202, the dielectric layer 212 and the first electrode 208 forms a dielectric layer capacitor.

Then, referring to FIG. 3B, the photo sense element of the present invention is configured on and above a baseboard 200. For example, a second electrode 210, a dielectric layer 212, a N-type doped layer 204, an intrinsic layer 206, a P-type doped layer 202 and a first electrode 208 are disposed in order on and above the baseboard 200. Wherein, since the intrinsic layer 206 is disposed in between the N-type doped layer 204 and the P-type doped layer 202, thus the N-type doped layer 204, P-type doped layer 202 and the intrinsic layer disposed in between forms a parasitic capacitor. Moreover, the N-type doped layer 204, the dielectric layer 212 and the second electrode 210 form a dielectric layer capacitor.

Then, referring to FIG. 3C, the photo sense element of the present invention is configured on and above a baseboard 200. For example, a first electrode 208, a P-type doped layer 202, an intrinsic layer 206, a N-type doped layer 204, a dielectric layer 212 and a second electrode 210 are disposed in order on and above the baseboard 200. Wherein, since the intrinsic layer 206 is disposed in between the N-type doped layer 204 and the P-type doped layer 202, thus the N-type doped layer 204, P-type doped layer 202 and the intrinsic layer disposed in between forms a parasitic capacitor. Moreover, the N-type doped layer 204, the dielectric layer 212 and the second electrode 210 form a dielectric layer capacitor.

Then, referring to FIG. 3D, the photo sense element of the present invention is configured on and above a baseboard 200. For example, a first electrode 208, a dielectric layer 212, a P-type doped layer 202, an intrinsic layer 206, a N-type doped layer 204 and a second electrode 210 are disposed in order on and above the baseboard 200. Wherein, since the intrinsic layer 206 is disposed in between the N-type doped layer 204 and the P-type doped layer 202, thus the N-type doped layer 204, P-type doped layer 202 and the intrinsic layer disposed in between form a parasitic capacitor. Moreover, the P-type doped layer 202, the dielectric layer 212 and the first electrode 208 form a dielectric layer capacitor.

The material of the dielectric layer 212 in FIG. 3A through FIG. 3D mentioned above is dielectric material such as the SiOx, SiNx, ferroelectric, polymer or other dielectric materials.

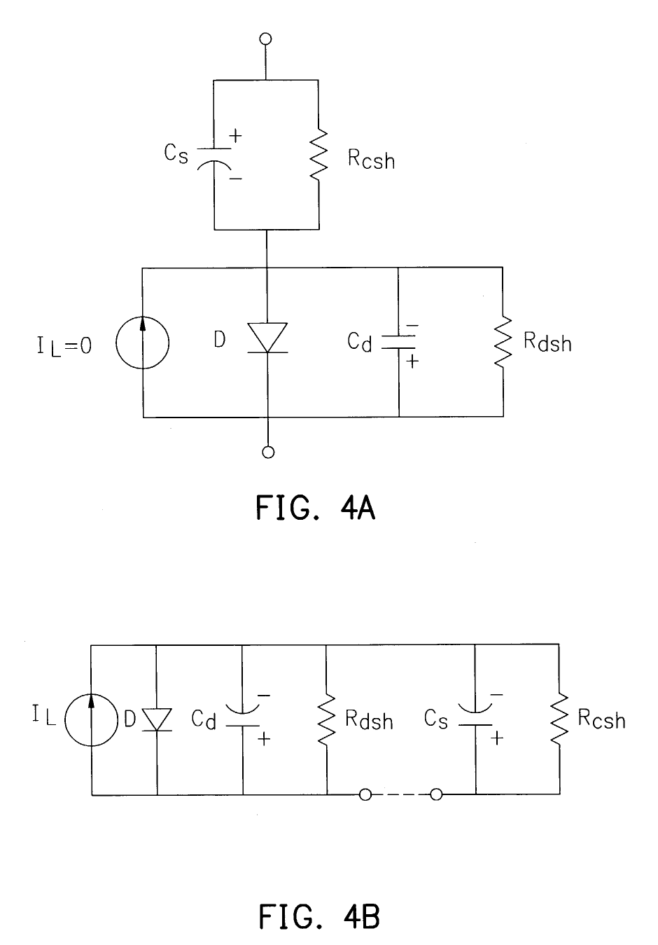

FIG. 4A and FIG. 4B schematically show the equivalent circuit diagrams of the photo sense element of a preferred embodiment according to the present invention. The photo sense element of the present invention can be treated as two portions; one portion is composed of in parallel a reverse bias total-equivalent capacitor C_{d}, an ideal diode D, a diode reverse bias leakage resistor R_{dsh}, and a photo sense current source I_{L}. Moreover, the other portion is composed of in parallel a dielectric layer capacitor Cₛ and a dielectric layer leakage resistor R_{csh}. The photo sense current source I_{L} is 0 when the photo sense element does not process the photo sensing.

In FIG. 4B, the photo sense element of the present invention, via appropriate circuit design, such as a virtual short of the diodes of the photo sense element or other equivalent method, so that the parasitic capacitor C_{d} that is formed from the P-type doped layer, the intrinsic layer and the N-type doped layer is in parallel with the dielectric layer capacitor Cₛ. After the parasitic capacitor C_{d} is in parallel with the dielectric layer capacitor Cₛ, the total capacitor value C_{T} of the photo sense element is equal to the summation of the parasitic capacitor C_{d} and the dielectric layer capacitor Cₛ, and is increased greatly.

The intrinsic layer of the photo sense element of the present invention is mainly used for the photo sensing, and the dielectric layer capacitor Cₛ is used to accumulate the photo current sensed by the intrinsic layer to form a portion of the total capacitor C_{T}, or the photo current sensed by the intrinsic layer is stored in the total capacitor C_{T} by using the manner of charge neutralization. The operation mode is described in detail hereafter. The dielectric layer capacitor Cₛ is a passive device composed of one terminal of the electrode, the dielectric layer and the diode. Thus, the manufacture of the dielectric layer capacitor Cₛ is very easy. Moreover, the capacitance of the dielectric layer capacitor Cₛ can be, by several tenfold times, greater than that of the parasitic capacitor C_{d}. In the case where the capacitance of the dielectric layer capacitor Cₛ is greater than that of the parasitic capacitor C_{d} byseveral tenfold times, since the dielectric layer capacitor Cₛ is in parallel with the parasitic capacitor C_{d}, thus the capacitance of the total capacitor C_{T} of the photo sense element is greatly increased, so that the capacitance of the total capacitor C_{T} does not easily get saturated. Therefore, the operation range of the photo sense element is increased.

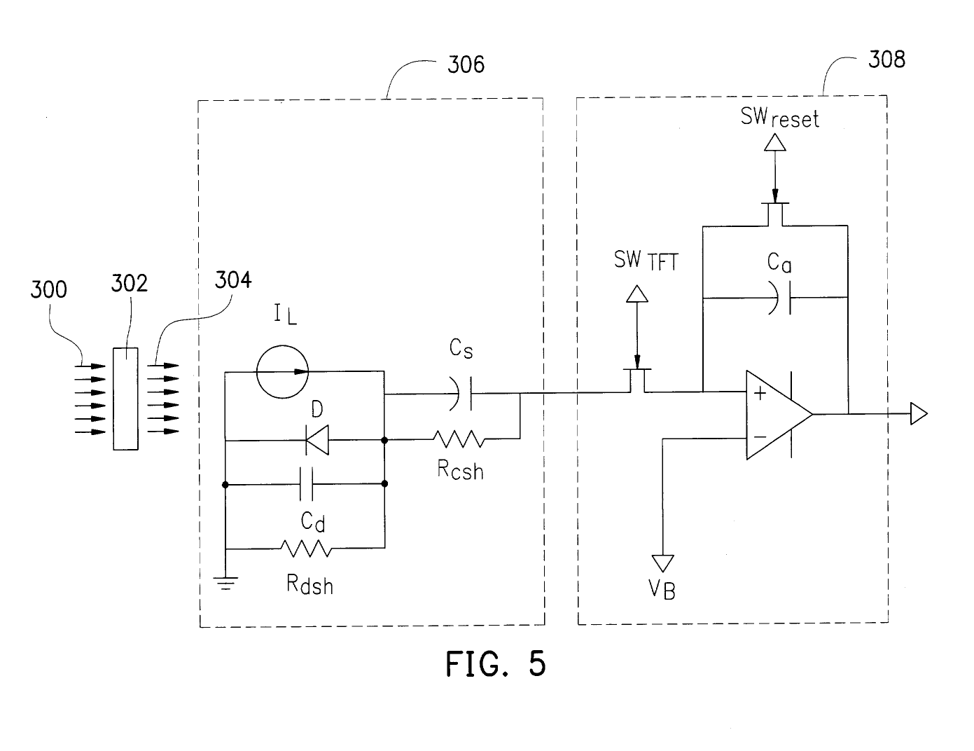

FIG. 5 schematically shows the equivalent circuit diagram of the photo sense element and the signal reading design of a preferred embodiment according to the present invention. When the photo sense element of the present invention is used as the indirect X-ray sense element, first, the X-ray 300 that is likely to be detected shoots onto a scintillator 302. After the X-ray 300 is converted to visible light 304 via the scintillator 302, the visible light 304 converted from the X-ray 300 is subsequently sensed via the photo sense element 306 of the present invention. Furthermore, after the photo sense element 306 has processed the photo sensing, the signal is detected via a circuit design 308.

Similarly, referring to FIG. 5, when the photo sense element 306 processes the photo sensing, since the parasitic capacitor C_{d} of the diode itself is in parallel with the dielectric layer capacitor Cₛ, thus the signal holding time (τ=RC) of the photo sense element 306 is longer. Therefore, the conventional disadvantage where the signal can not be read due to the capacitor value being too small does not occur. Furthermore, the circuit design 308 for reading out the signal is able to close the membrane transistor SW_{TFT} when the signal is waiting to be read out. Therefore, the objective of extending the signal holding time can be achieved.

When the photo sense element of the present invention is used as an indirect X-ray sense element, one of the operation modes, for example, may comprise following steps:

At first, before the photons are sensed, the photo sense element processes the charge operation to the dielectric layer capacitor of the element to a certain voltage level by using a positive bias, the voltage value being such as 2 volts to 10 volts.

Then, if the voltage level between the diodes is reduced to such as 0 volt to process the operation of the photo sensing, since there is an initial voltage contained in the dielectric layer after the charging, the initial voltage is such as 2 volts to 10 volts. Thus, the diode is processing the operation of the photo sensing under a reverse bias state of 2 volts to 10 volts. At this moment, the photo current generated by the photo sensing will neutralize the charge of the dielectric layer capacitor.

After photons are sensed, a positive bias is applied to the dielectric layer capacitor to process the charging again. The dielectric layer capacitor is charged again to a certain voltage level, such as 2 volts to 10 volts, so that the charge that is neutralized by the photo current when photons are sensed is read out. Since the intensity of the photo current and the time of the occurrence is positive proportional to the quantity and the intensity of the incident photons, therefore, the total photons of the incident light and the dose of the X-ray can be calculated via the read out charge.

When the photo sense element of the present invention is used as the indirect X-ray sense element, the other operation mode, for example, may comprise the following steps:

At first, before the photons are sensed, the photo sense element applies a reverse bias in between the diodes, the reverse bias is such as 2 volts to 10 volts. The reverse bias charges the dielectric layer capacitor first, after the charging approaches to the steady state, most of the voltage is falling on the dielectric layer.

Afterwards, the reverse bias is maintained in between the diodes and the operation of the photo sensing is processed. Since the charging is in the steady state, thus the diode is processing the photo sensing under a no bias state. The diode forms like a photo volt battery via the irradiation of the light, so that the charging loop voltage raises the voltage value of the photo volt battery and continuously charges the dielectric layer capacitor.

Finally, the charge is increased on the dielectric layer capacitor when the photons sensed are read out, thus the total photons of the incident light and the dose of the X-ray can be calculated via the read out charge.

In summary, the photo sense element of the present invention at least has the following advantages:

1. In the photo sense element of the present invention, a dielectric layer is disposed in between one terminal of the electrode and the diode to form a dielectric layer capacitor. Since the dielectric layer capacitor is a passive device, in the aspect of the manufacture, via the process or the material selection, the capacitance of the dielectric layer capacitor can be higher than that of the parasitic capacitor several tenfold times or more.

2. The photo sense element accompanied with appropriate circuit design makes the parasitic capacitor in parallel with the dielectric layer capacitor to obtain higher capacitor value, so the photo sense element of the present invention does not easily get saturated and has a bigger operation range.

3. The photo sense element of the present invention has the advantages of fast reading, ease of manufacture, and high manufacture yield rate.

4. The independent optimum design of the capacitor of the accumulated charge and the photo sense diode can be achieved by using the structure of the photo sense element of the present invention. It is different when only one photo sense diode is used, where the same photo sense diode has to consider all the problems such as the charge storage efficiency, the photo sense sensitivity, and the quantity of the noise. Therefore, the photo sense element of the present invention is easy to design, easy to manufacture, and it is easy to enhance the yield rate.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A photo sense element, at least comprising:
a diode, wherein the diode comprises a first type doped layer, an intrinsic layer and a second type doped layer, the intrinsic layer is disposed in between the first type doped layer and the second doped layer, the diode has a parasitic capacitor under a reverse bias state;
a first electrode, wherein the first electrode is electrically connected to the first type doped layer;
a second electrode, wherein the second electrode is corresponded to the second type doped layer; and
a dielectric layer, wherein the dielectric layer is disposed in between the second electrode and the second type doped layer, so as to the second electrode, the dielectric layer and the second type doped layer forms a dielectric layer capacitor.

2. The photo sense element of claim 1, wherein the first type doped layer is N-type doped, the second type doped layer is P-type doped.

3. The photo sense element of claim 1, wherein the first type doped layer is P-type doped, the second type doped layer is N-type doped.

4. The photo sense element of claim 1, wherein the material of the dielectric layer comprises SiOx, SiNx, ferroelectric and polymer.

5. The photo sense element of claim 1, wherein the operation mode comprises:
before the photons are sensed, providing a first positive bias in between the first electrode and the second electrode to charge the dielectric layer capacitor to a first voltage;
wherein when the photo sensing is processing, reducing the first positive bias, so that the second diode processes the photo sensing under the reverse bias state, and partial of the charge of the dielectric layer capacitor is neutralized; and
after photons are sensed, providing a second positive bias in between the first electrode and the second electrode to charge the dielectric layer capacitor to the first voltage.

6. The photo sense element of claim 1, wherein the operation mode comprises:
before the photons are sensed, providing a reverse bias in between the first electrode and the second electrode to charge the dielectric layer capacitor and the parasitic capacitor; and
wherein when the photo sensing is processing, maintaining the reverse bias, so as to the diode processes the photo sensing under the no bias state and charges the dielectric layer capacitor continuously.

7. A photo sense element, at least comprising:
a diode, wherein the diode comprises a first type doped layer, an intrinsic layer and a second type doped layer, the intrinsic layer is disposed in between the first type doped layer and the second type doped layer, the diode has a parasitic capacitor under a reverse bias state;
a dielectric layer, wherein the dielectric layer is disposed on the first type doped layer of the diode;
a first conductor layer, wherein the first conductor layer is disposed on the dielectric layer, so as to the first conductor layer electrode, the dielectric layer and the first type doped layer forms a dielectric layer capacitor; and
a second conductor layer, wherein the second conductor layer is disposed on the second type doped layer.

8. The photo sense element of claim 7, wherein the first type doped layer is N-type doped, the second type doped layer is P-type doped.

9. The photo sense element of claim 7, wherein the first type doped layer is P-type doped, the second type doped layer is N-type doped.

10. The photo sense element of claim 7, wherein the material of the dielectric layer comprises SiOx, SiNx, ferroelectric and polymer.

11. The photo sense element of claim 7, wherein the operation mode comprises:
before the photons are sensed, providing a first positive bias in between the first conductor layer and the second conductor layer to charge the dielectric layer capacitor to a first voltage;
wherein when the photo sensing is processing, reducing the first positive bias, so as to the second diode processes the photo sensing under the reverse bias state, and partial of the charge of the dielectric layer capacitor is neutralized; and
after the photons are sensed, providing a second positive bias in between the first conductor layer and the second conductor layer to charge the dielectric layer capacitor to the first voltage.

12. The photo sense element of claim 7, wherein the operation mode comprises:
before the photons are sensed, providing a reverse bias in between the first conductor layer and the second conductor layer to charge the dielectric layer capacitor and the parasitic capacitor; and wherein when the photo sensing is processing, maintaining the reverse bias, so as to the diode processes the photo sensing under the no bias state and charges the dielectric layer capacitor. continuously.
